(19) United States
(12) Patent Application Publication
(10) Pub. No.: US 2012/0228996 A1
(43) Pub. Date: Sep. 13, 2012

(54) DRIVING APPARATUS

(75) Inventor: Jun Suzuki, Saitama (JP)

(73) Assignee: Pioneer Corporation, Kanagawa (JP)

(21) Appl. No.: 13/510,773

(22) PCT Filed: Nov. 19, 2009
(86) PCT No.: PCT/JP2009/069637

§ 371 Date: May 30, 2012

(51) Int. Cl. H02N 11/00; H02N 2/00

(52) U.S. Cl. 310/323.01; 310/300

(57) ABSTRACT

A driving apparatus (100) is provided with: a base part (110); a driven part (130) capable of rotating around an axis which is along one direction (Y-axis); an elastic part (120) which connects the base part and the driven part and which extends along the one direction; and an applying part (140) for applying a force for expanding and contracting the elastic part along the one direction as an excitation force for rotating the driven part such that the driven part resonates at a resonance frequency determined by the elastic part and the driven part.

### TECHNICAL FIELD

The present invention relates to a driving apparatus such as, for example, a MEMS scanner for rotating a driven object such as a mirror.

### BACKGROUND ART

In various technical fields such as, for example, a display, a printing apparatus, precision measurement, precision processing, and information recording-reproduction, research on a micro electro mechanical system (MEMS) device manufactured by a semiconductor fabrication technology is actively progressing. As the MEMS device as described above, a mirror driving apparatus having a microscopic structure (a light scanner or a MEMS scanner) attracts attention, for example, in a display field in which images are displayed by scanning a predetermined screen area with light which enters from a light source, or in a scanning field in which a predetermined screen area is scanned with light and image information is read by receiving reflected light.

There is known a mirror driving apparatus which is provided with: a fixed main body to be a base; a mirror capable of rotating around a predetermined central axis; and a torsion bar (a torsion member) for connecting or joining the main body and the mirror (refer to a patent document 1).

### PATENT DOCUMENT

Patent document 1: Published Japanese translation of a PCT application (Tokuhyo) No. 2007-522529

### DISCLOSURE OF INVENTION

### Subject to be Solved by the Invention

In the mirror driving apparatus having such a configuration, it is general that the mirror is driven by using a coil and a magnet. As one example of such a configuration, for example, there is listed a configuration in which the coil is directly attached to the mirror. In this case, due to an interaction between a magnetic field of the magnet and a magnetic field generated by applying an electric current to the coil, a force in a rotational direction is directly applied to the mirror, resulting in the rotation of the mirror. Moreover, in the aforementioned patent document 1, there is adopted such a configuration that the coil and the magnet are disposed to directly cause a distortion in a torsional direction (in other words, a direction of an axis of the rotation of the mirror) to the torsion bar. In this case, due to the interaction between the magnetic field of the magnet and the magnetic field generated by applying the electric current to the coil, the torsion bar is distorted in the torsional direction, and the distortion in the torsional direction of the torsion bar causes the rotation of the mirror.

For the conventional mirror driving apparatus as described above, it is therefore an object of the present invention to provide a driving apparatus (i.e. MEMS scanner) capable of driving the mirror (or driven object which rotates) by using the action of a force other than a force directly causing the rotation of the mirror or other than a force directly causing the distortion in the torsional direction of the torsion bar (by using the action of a force other than a force acting in the rotational direction of the mirror).

The above object of the present invention can be achieved by a driving apparatus provided with: a base part; a driven part capable of rotating around an axis along one direction; an elastic part which connects the base part and the driven part and which extends along the one direction; and an applying part for applying a force for expanding and contracting the elastic part along the one direction as an excitation force for rotating the driven part such that the driven part resonates at a resonance frequency determined by the elastic part and the driven part.

These operation and other advantages of the present invention will become more apparent from the embodiment explained below.

### BRIEF DESCRIPTION OF DRAWINGS

FIG. 1 is a plan view conceptually showing a configuration of a driving apparatus in a first example.

FIG. 2 are a plan view conceptually showing an aspect of operation performed by the driving apparatus in the first example and a graph conceptually showing a signal waveform of a force applied from driving source parts when the driving apparatus in the first example performs driving.

FIG. 3 is a plan view conceptually showing a configuration of a driving apparatus in a second example.

FIG. 4 is a plan view conceptually showing a configuration of a driving apparatus in a third example.

FIG. 5 are plan views conceptually showing an aspect of operation performed by the driving apparatus in the third example.

FIG. 6 is a plan view conceptually showing a configuration of a driving apparatus in a fourth example.

FIG. 7 are plan views conceptually showing an aspect of operation performed by the driving apparatus in the fourth example.

### BEST MODE FOR CARRYING OUT THE INVENTION

Hereinafter, as the best mode for carrying out the present invention, an explanation will be given to an embodiment of the driving apparatus in order.

A driving apparatus in the embodiment is provided with: a base part; a driven part capable of rotating around an axis along one direction; an elastic part which connects the base part and the driven part and which extends along the one direction; and an applying part for applying a force for expanding and contracting the elastic part along the one direction as an excitation force for rotating the driven part such that the driven part resonates at a resonance frequency determined by the elastic part and the driven part.

According to the driving apparatus in the embodiment, the base part which is a foundation and the driven part (e.g. a mirror described later, etc.) which is disposed so as to rotate are connected directly or indirectly by the elastic part (e.g. a torsion bar described later, etc.) having the elasticity. The driven part is driven so as to rotate around the axis along the one direction by the elasticity of the elastic part (e.g. elasticity capable of rotating the driven part around the axis along the one direction). Moreover, the elastic part extends along the one direction. In other words, the elastic part has a shape having a longitudinal structure (longitudinal shape) along the one direction (in other words, a direction along the central axis of the rotation of the driven part) and having a shorter structure (shorter shape) along another direction perpendicular to the one direction.

In the driving apparatus in the embodiment, by operation of the applying part, the excitation force is applied such that the driven part rotates around the axis along the one direction. In particular, by the operation of the applying part, the excitation force is applied such that the driven part resonates at the resonance frequency determined by the elastic part and the driven part. In other words, due the excitation force applied from the applying part, the driven part rotates (in other words, moves) while resonating at the resonance frequency. Incidentally, the “rotation” herein does not necessarily mean a rotation of 360 degrees but in effect widely indicates a state of rotating to some degree around the axis along the one direction (e.g. a state of rotating within a limited range of angles or a state of repeating the rotational motion within a limited range of angles).

In the embodiment, in particular, the applying part applies the force for expanding and contracting the elastic part along the one direction as the excitation force described above, periodically, non-periodically, regularly, irregularly, continuously, discontinuously, or in other aspects. In other words, the applying part applies the force for extending or compressing (or scaling down) the elastic part as the excitation force described above. More specifically, considering that the elastic part extends along the one direction, in the embodiment, the applying part applies, to the elastic part, a force acting along a direction perpendicular to a rotational direction of the driven part (i.e. a direction along the central axis of the rotation of the driven part, or the one direction) as the excitation force, thereby expanding and contracting the elastic part along the one direction. As a result, vibration or motion caused by the expansion and contraction along the one direction of the elastic part is transmitted to the driven part, and the driven part rotates around the axis along the one direction.

By this, in the embodiment, it is no longer necessary to directly apply a force directly causing the rotation of the driven part or a force directly causing a distortion along a torsional direction of the elastic part (i.e. the rotational direction of the driven part) or a force acting along the rotational direction of the driven part as the excitation force. On the other hand, the driven part can be rotated in the same aspect as that in the case of applying an excitation force directly causing the distortion along the torsional direction of the elastic part.

In one aspect of the driving apparatus in the embodiment, the elastic part is integrated with the applying part and includes a piezoelectric element.

According to this aspect, by applying a voltage to the elastic part including the piezoelectric element, the elastic part expands and contracts along the one direction. As a result, the driven part can be rotated around the axis along the one direction.

In another aspect of the driving apparatus in the embodiment, the applying part directly applies, to the elastic part, the force for expanding and contracting the elastic part along the one direction as the excitation force, and the elastic part is expanded and contracted along the one direction as the excitation force.

According to this aspect, the excitation is directly applied to the elastic part, by which the elastic part can be expanded and contracted along the one direction. As a result, the driven part can be rotated around the axis along the one direction.

In another aspect of the driving apparatus in the embodiment, the base part has a frame shape with a space therein, the driven part is disposed in the space of the base part so as to be surrounded by the base part, one end of the elastic part along the one direction is connected to the base part, and the other end of the elastic part along the one direction is connected to the driven part, the applying part applies, to the base part, the force for expanding and contracting the elastic part along the one direction as the excitation force, and the base part is distorted due to the excitation force, and the elastic part is expanded and contracted along the one direction in accordance with the distortion of the base part.

According to this aspect, the one end of the elastic part and the base part are connected, and the other end of the elastic part and the driven part are connected. In other words, the base part and the elastic part are disposed to align along the one direction. Moreover, instead of the excitation force being directly applied to the elastic part, the excitation force is applied to the base part. Since the shape of the base part is the frame shape with the space therein, the distortion of the base part, to which the excitation force is applied, occurs along the direction of the excitation force in. Thus, the distortion of the base part causes the expansion and contraction of the elastic part connected to the base part. At this time, the driven part is preferably disposed such that a position of the driven part along the one direction hardly changes or does not change at all. Specifically, for example, if a force acting along a direction of bringing the base part close to the elastic part (in other words, a force acting so as to compress the elastic part) is applied to the base part as the excitation force, the base part is distorted so as to compress (or scale down) the elastic part. Therefore, in this case, the elastic part is compressed. On the other hand, for example, if a force acting along a direction of bringing the base part far from the elastic part (in other words, a force acting so as to extend the elastic part) is applied to the base part as the excitation force, the base part is distorted so as to extend the elastic part. Therefore, in this case, the elastic part is extended. By this, even if the excitation force is not directly applied to the elastic part, the elastic part can be expanded and contracted along the one direction. As a result, the driven part can be rotated around the axis along the one direction.

In another aspect of the driving apparatus in the embodiment, the base part has a frame shape with a space therein, the driven part is disposed in the space of the base part so as to be surrounded by the base part, the elastic part is provided with: (i) a one-side elastic part for connecting one area portion out of two area portions of the base part which face to each other along the one direction and an area portion of the driven part facing to the one area portion; and (ii) an other-side elastic part for connecting the other area portion out of the two area portions of the base part which face to each other along the one direction and an area portion of the driven part facing to the other area portion, and the applying part applies the excitation force such that an aspect of expanding and contracting the one-side elastic part is synchronized with an aspect of expanding and contracting the other-side elastic part.

According to this aspect, the elastic part is provided with the one-side elastic part and the other-side elastic part. The one-side elastic part connects the one area portion out of the two area portions of the base part which face to each other along the one direction and the area portion of the driven part facing to the one area portion. The other-side elastic part connects the other area portion out of the two area portions of the base part which face to each other along the one direction and the area portion of the driven part facing to the other area portion. In other words, in this aspect, the one area portion of the base part, the one-side elastic part, the driven part, the other-side elastic part, and the other area portion of the base part are arranged to align along the one direction. More specifically, for example, if the base part has a rectangular shape such as an square and an oblong and if the driven part has a rectangular shape such as an square and an oblong, the one-side elastic part connects one side out of two sides of the base part which face to each other (in other words, two sides facing the space) and a side of the driven part facing to the one side of the base part. In the same manner, the other-side elastic part connects the other side out of the two sides of the base part which face to each other and a side of the driven part facing to the other side of the base part.

In this aspect, in particular, by the operation of the applying part, the excitation force is applied such that the aspect of expanding and contracting the one-side elastic part and the aspect of expanding and contracting the other-side elastic part are synchronized with each other. For example, if the one-side elastic part is compressed, the other-side elastic part which is disposed on the opposite side of the one-side elastic part via the driven part is also compressed in the same manner. In the same manner, for example, if the one-side elastic part is extended, the other-side elastic part which is disposed on the opposite side of the one-side elastic part via the driven part is also extended in the same manner. This no longer allows the driven part to be disposed to be biased toward the one-side elastic part side or to be disposed to be biased toward the other-side elastic part side due to the expansion and contraction of the elastic part. In other words, the driven part is almost no longer unintentionally displaced along the one direction. Therefore, the stability of the posture of the driven part can be preferably maintained.

In an aspect of the driving apparatus in which the excitation force is applied such that the direction of the expansion and contraction of the one-side elastic part and the direction of the expansion and contraction of the other-side elastic part are opposite to each other, the applying part may apply the excitation force such that an absolute value of an amount of expansion and contraction of the one-side elastic part is same as an absolute value of an amount of expansion and contraction of the other-side elastic part.

By virtue of such a configuration, by the operation of the applying part, the excitation force is applied such that the aspect of expanding and contracting the one-side elastic part and the aspect of expanding and contracting the other-side elastic part are synchronized with each other and such that the absolute value of the amount of expansion and contraction of the one-side elastic part and the absolute value of the amount of expansion and contraction of the other-side elastic part are the same as each other. For example, if the one-side elastic part is compressed by a predetermined amount, the other-side elastic part which is disposed on the opposite side of the one-side elastic part via the driven part is also compressed by the predetermined amount in the same manner. In the same manner, for example, if the one-side elastic part is extended by a predetermined amount, the other-side elastic part which is disposed on the opposite side of the one-side elastic part via the driven part is also extended by the predetermined amount in the same manner. This no longer allows the driven part to be disposed to be biased toward the one-side elastic part side or to be disposed to be biased toward the other-side elastic part side due to the expansion and contraction of the elastic part. In other words, the driven part is almost no longer unintentionally displaced along the one direction. Therefore, the stability of the posture of the driven part can be preferably maintained.

In another aspect of the driving apparatus in the embodiment, the base part is provided with: a first base part; and a second base part surrounded by the first base part, the elastic part is provided with: a first elastic part which connects the first base part and the second base part and which extends along another direction which is different from the one direction; and a second elastic part which connects the second base part and the driven part and which extends along the one direction, and the applying part (i) applies a driving force for rotating the second base part around an axis along the another direction and (ii) uses the driving force as the excitation force which becomes a force for expanding and contracting the second elastic part along the one direction.

According to this aspect, the second base part is supported (in other words, hung) on the first base part by the first elastic part, and the driven part is supported (in other words, hung) on the second base part by the second elastic part. Moreover, the applying part applies the driving force for rotating the second base part around the axis along the another direction. As a result, the second base part rotates around the axis along the another direction, using the elasticity of the first elastic part. In addition, the applying part uses the driving force described above as the force for expanding and contracting the second elastic part along the one direction (i.e. the excitation force for rotating the driven part around the axis along the one direction). As a result, the driven part rotates around the axis along the one direction, using the elasticity of the second elastic part.

Here, since the driven part is supported on the second base part by the second elastic part and the second base part rotates around the axis along the another direction, the driven part rotates around the axis along the one direction and rotates around the axis along the another direction. In other words, according to this aspect, it is possible to realize biaxial rotational drive of the driven part. In addition, according to this aspect, it is possible to realize the rotation of the driven part around the axis along the one direction and the rotation of the driven part around the axis along the another direction, by using the force applied from a single applying part. Thus, there is such an extremely useful effect in practice that it is not necessary to separately and independently provide an applying part for realizing the rotation of the driven part around the axis along the one direction and an applying part for realizing the rotation of the driven part around the axis along the another direction.

These operation and other advantages in the embodiment will become more apparent from the examples explained below.

As explained above, according to the driving apparatus in the embodiment is provided with: the base part; the driven part; the elastic part; and the applying part. Therefore, it is no longer necessary to directly apply the force directly causing the rotation of the driven part or the excitation force directly causing the distortion along the torsional direction of the elastic part. On the other hand, the driven part can be rotated in the same aspect as that in the case of applying the excitation force directly causing the distortion along the torsional direction of the elastic part.

### EXAMPLES

Hereinafter, with reference to the drawings, examples of the driving apparatus will be explained. Incidentally, hereinafter, an explanation will be given to an example in which the driving apparatus is applied to a MEMS scanner.

### (1) First Example

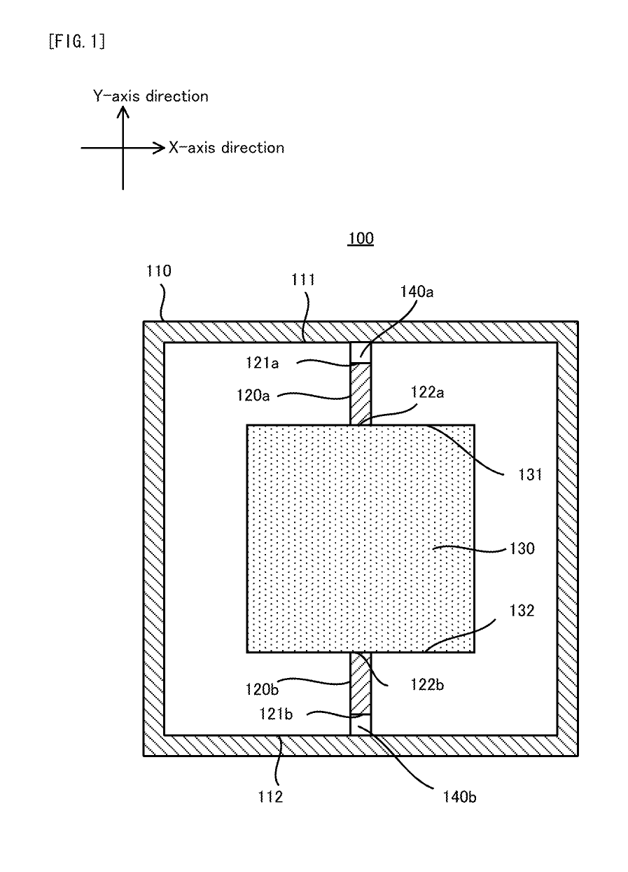

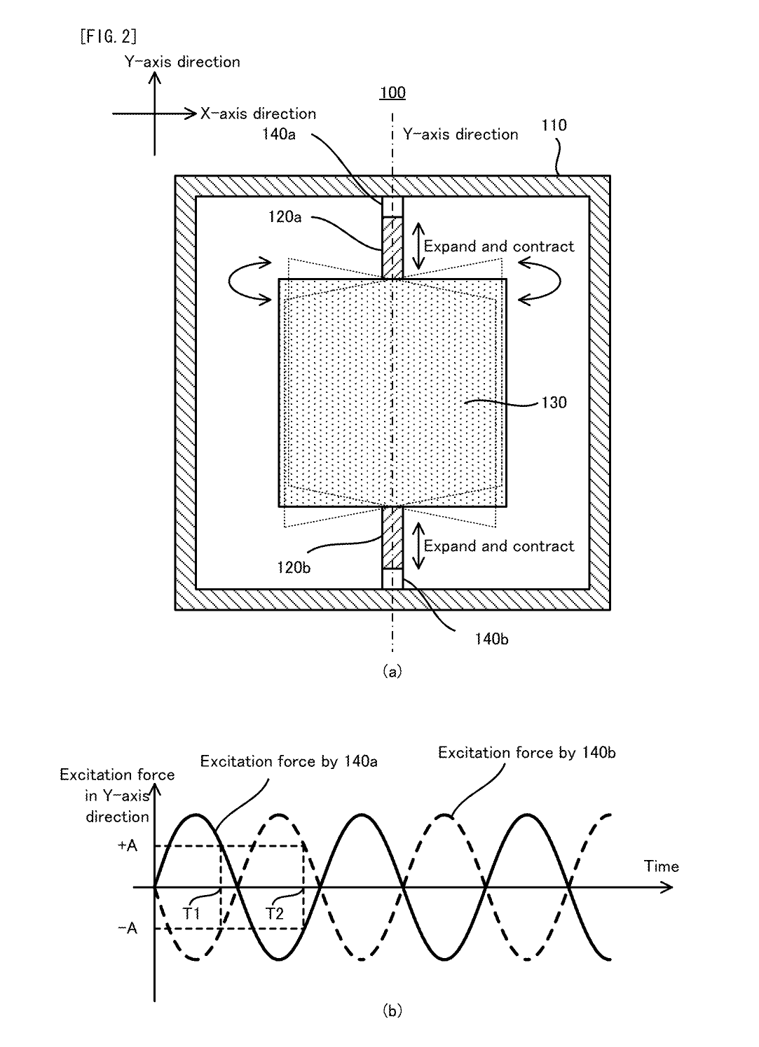

Firstly, with reference to FIG. 1 and FIG. 2, a first example of the MEMS scanner will be explained.

(1-1) Basic Configuration

Firstly, with reference to FIG. 1, a basic configuration of a MEMS scanner 100 in the first example will be explained. FIG. 1 is a plan view conceptually showing the basic configuration of the MEMS scanner 100 in the first example.

As shown in FIG. 1, the MEMS scanner 100 in the first example is provided with: a base 110 which constitutes one specific example of the “base part” described above; a torsion bar 120a which constitutes one specific example of the “elastic part (or one-side elastic part)” described above; a torsion bar 120b which constitutes one specific example of the “elastic part (or other-side elastic part)” described above; a mirror 130 which constitutes one specific example of the “driven part” described above; a driving source part 140a which constitutes one specific example of the “applying part” described above; and a driving source part 140b which constitutes one specific example of the “applying part” described above.

The base 110 has a frame shape with a space therein. In other words, the base 110 has a frame shape having two sides extending along a Y-axis direction in FIG. 1 and two sides extending along an X-axis direction (i.e. an axial direction perpendicular to the Y-axis) in FIG. 1 and having a space surrounded by the two sides extending along the Y-axis direction and the two sides extending along the X-axis direction. In an example shown in FIG. 1, the base 110 has, but not limited to, a square shape. For example, the base 110 may have another shape (e.g. rectangular shape such as an oblong, a circular shape, etc.). Moreover, the base 110 is a structure which is the foundation of the MEMS scanner 100 in the first example and is preferably fixed to a not-illustrated substrate or support member (in other words, is fixed in the inside of a system which is the MEMS scanner 100).

Incidentally, FIG. 1 shows the example in which the base 110 has the frame shape, but obviously the base 110 may have another shape. For example, the base 110 may have a box shape with a space therein. In other words, the base 110 may have a box shape having two surfaces distributed on a plane defined by the X-axis and the Y-axis, two surfaces distributed on a plane defined by the X-axis and a not-illustrated Z-axis (i.e. a Z-axis perpendicular to both the X-axis and the Y-axis), and two surfaces distributed on a plane defined by the Y-axis and the not-illustrated Z-axis, and having a space surrounded by the six surfaces. Alternatively, the shape of the base 110 may be arbitrarily changed depending on an arrangement aspect of the mirror 130.

The torsion bar 120a is, for example, an elastic member such as a spring made of silicone, copper alloy, iron-based alloy, other metal, resin, or the like. The torsion bar 120a is disposed to extend along the Y-axis direction in FIG. 1. In other words, the torsion bar 120a has a shape having a long side extending along the Y-axis direction and a short side extending along the X-axis direction. However, in accordance with a setting situation of a resonance frequency described later, the torsion bar 120a may have a shape having a short side extending along the Y-axis direction and a long side extending along the X-axis direction. One end 121a of the torsion bar 120a is connected to a side 111 on the inner side of the base 110 via the driving source part 140a. The other end 122a of the torsion bar 120a is connected to one side 131 of the mirror 130 opposed to the side 111 on the inner side of the base 110 along the Y-axis direction.

In the same manner, the torsion bar 120b is, for example, an elastic member such as a spring made of silicone, copper alloy, iron-based alloy, other metal, resin, or the like. The torsion bar 120b is disposed to extend along the Y-axis direction in FIG. 1. In other words, the torsion bar 120b has a shape having a long side extending along the Y-axis direction and a short side extending along the X-axis direction. However, in accordance with the setting situation of the resonance frequency described later, the torsion bar 120b may have a shape having a short side extending along the Y-axis direction and a long side extending along the X-axis direction. One end 121b of the torsion bar 120b is connected to a side 112 on the inner side of the base 110 opposed to the side (in other words, area portion) 111 on the inner side of the base 110 (i.e. the side 111 on the inner side of the base 110 to which the one end 121a of the torsion bar 120a is connected) via the driving source part 140b. The other end 122b of the torsion bar 120b is connected to the other side 132 of the mirror 130 opposed to the side 112 on the inner side of the base 110 along the Y-axis direction. In other words, in the first example, the base 110, the torsion bars 120a and 120b, the mirror 130, and the driving source parts 140a and 140b are disposed such that the side 111 on the inner side of the base 110, the driving source part 140a, the torsion bar 120a, the one side 131 of the mirror 130, the mirror 130, the other side 132 of the mirror 130, the torsion bar 120, the driving source part 140b, and the side 112 on the inner side of the base 110 are arranged in this order along the Y-axis direction.

The mirror 130 is disposed in the space in the inside of the base 110 so as to be hung or supported by the torsion bars 120a and 120b. The mirror 130 is configured to rotate around an axis along the Y-axis direction, by the elasticity of the torsion bars 120a and 120b.

The driving source part 140a is fixed to each of the side 111 on the inner side of the base 110 and the one end 121a of the torsion bar 120a so as to be sandwiched between the side 111 on the inner side of the base 110 and the one end 121a of the torsion bar 120a. The driving source part 140a applies, to the torsion bar 120a, a force for expanding and contracting the torsion bar 120a along the Y-axis direction. More specifically, the driving source part 140a applies, to the torsion bar 120a, a force for expanding the torsion bar 120a along the Y-axis direction (specifically, for example, a force pulling the torsion bar 120a toward a positive direction of the Y-axis (upward in FIG. 1) and a force acting toward the positive direction of the Y-axis) and a force for compressing the torsion bar 120a along the Y-axis direction (specifically, for example, a force pushing the torsion bar 120a toward a negative direction of the Y-axis (downward in FIG. 1) and a force acting toward the negative direction of the Y-axis).

In the same manner, the driving source part 140b is fixed to each of the side 112 on the inner side of the base 110 and the one end 121b of the torsion bar 120b so as to be sandwiched between the side 112 on the inner side of the base 110 and the one end 121b of the torsion bar 120b. The driving source part 140b applies, to the torsion bar 120b, a force for expanding and contracting the torsion bar 120b in the Y-axis direction. More specifically, the driving source part 140b applies, to the torsion bar 120b, a force for expanding the torsion bar 120b along the Y-axis direction (specifically, for example, a force pulling the torsion bar 120b toward the negative direction of the Y-axis (downward in FIG. 1) and a force acting toward the negative direction of the Y-axis) and a force for compressing the torsion bar 120b along the Y-axis direction (specifically, for example, a force pushing the torsion bar 120b toward the positive direction of the Y-axis (upward in FIG. 1) and a force acting toward the positive direction of the Y-axis).

As specific examples of each of the driving source parts 140a and 140b, (i) a driving source part for applying a force caused by a piezoelectric effect, (ii) a driving source part for applying a force caused by an electromagnetic force, and (iii) a driving source part for applying a force caused by an electrostatic force are listed as one example. Of course, other methods may be also used.

For example, the driving source part for applying the force caused by the piezoelectric effect is provided with: a first electrode fixed to the base 110; a second electrode fixed to the torsion bar 120a (or torsion bar 120b); and a piezoelectric element sandwiched between the first electrode and the second electrode. In this case, a desired voltage is applied to at least one of the first electrode and the second electrode in desired timing from a not-illustrated driving source part control circuit. Due to the application of the voltage to at least one of the first electrode and the second electrode, the piezoelectric element changes its shape. Here, since the first electrode is fixed to the base 110 which is the foundation and the second electrode is fixed to the torsion bar 120a (or torsion bar 120b), the change in the shape of the piezoelectric element is applied to the torsion bar 120a (or torsion bar 120b) as a force via the second electrode. As a result, the force caused by the change in the shape of the piezoelectric element due to the voltage application (i.e. piezoelectric effect) is applied to the torsion bar 120a (or torsion bar 120b).

For example, the driving source part for applying the force caused by the electromagnetic force is provided with: a magnetic pole fixed to the base 110; and a coil fixed to the torsion bar 120a (or torsion bar 120b). In this case, a desired voltage is applied to the coil in desired timing from a not-illustrated driving source part control circuit. The application of the voltage to the coil causes an electric current to flow and causes an electromagnetic interaction between the coil and the magnetic pole. As a result, an electromagnetic force is generated by the electromagnetic interaction. Here, since the magnetic pole is fixed to the base 110 which is the foundation and the coil is fixed to the torsion bar 120a (or torsion bar 120b), a force caused by the electromagnetic force is applied to the torsion bar 120a (or torsion bar 120b). As a result, the force caused by the electromagnetic force is applied to the torsion bar 120a (or torsion bar 120b).

Moreover, the driving source part for applying the force caused by the electrostatic force is provided with: a first comb-like (or interdigitated) electrode fixed to the base 110; and a second comb-like (or interdigitated) electrode fixed to the torsion bar 120a (or torsion bar 120b) and distributed in such a manner that the first electrode and the second electrode interdigitate each other). In this case, a desired voltage is applied to the first electrode in desired timing from a not-illustrated driving source part control circuit. Due to a potential difference between the first electrode and the second electrode, an electrostatic force (in other words, Coulomb force) is generated between the first electrode and the second electrode. Here, since the first electrode is fixed to the base 110 which is the foundation and the second electrode is fixed to the torsion bar 120a (or torsion bar 120b), a force caused by the electrostatic force is applied to the torsion bar 120a (or torsion bar 120b). As a result, the force caused by the electromagnetic force is applied to the torsion bar 120a (or torsion bar 120b).

(1-2) Operation of MEMS Scanner

Next, with reference to FIG. 2, an explanation will be given to an aspect of the operation of the MEMS scanner 100 in the first example (specifically, an aspect of the operation of rotating the mirror 130). FIG. 2 are a plan view conceptually showing the aspect of the operation performed by the MEMS scanner 100 in the first example and a graph conceptually showing a signal waveform of a force applied from the driving source parts 140a and 140b if the MEMS scanner 100 in the first example performs driving.

As shown in FIG. 2(a), when the mirror 130 rotates, the driving source part 140a applies a force to the torsion bar 120a. Here, the driving source part 140a applies a force to the torsion bar 120a so as to repeat the expansion and contraction of the torsion bar 120a along the Y-axis direction. As a result, the torsion bar 120a repeatedly expands and contracts along the Y-axis direction.

At the same time, when the mirror 130 rotates, the driving source part 140b applies a force to the torsion bar 120b. Here, the driving source part 140b applies a force to the torsion bar 120b so as to repeat the expansion and contraction of the torsion bar 120a along the Y-axis direction. As a result, the torsion bar 120b repeatedly expands and contracts along the Y-axis direction.

Incidentally, in the explanation below, a force applied to rotate the mirror 130 (particularly, rotate the mirror 130 at a resonance frequency), in other words, a force applied to expand and contract the torsion bars 120a and 120b, will be referred to as an “excitation force”.

Here, as shown in FIG. 2(b), an aspect of the expansion and contraction of the torsion bar 120a is preferably synchronized with an aspect of the expansion and contraction of the torsion bar 120b. Specifically, when the driving source part 140a applies an excitation force for compressing the torsion bar 120a along the Y-axis direction, the driving source part 140b also preferably applies an excitation force for compressing the torsion bar 120b along the Y-axis direction. As a result, when the torsion bar 120a is compressed along the Y-axis direction, the torsion bar 120b is also compressed along the Y-axis direction. More specifically, as shown in FIG. 2(b), when the driving source part 140a applies an excitation force for compressing the torsion bar 120a along the Y-axis direction (specifically, for example, a force pushing the torsion bar 120a toward the negative direction of the Y-axis (downward in FIG. 2(a)) and a force acting toward the negative direction of the Y-axis), the driving source part 140b also preferably applies an excitation force for compressing the torsion bar 120b along the Y-axis direction (specifically, for example, a force pushing the torsion bar 120b toward the positive direction of the Y-axis (upward in FIG. 2(a)) and a force acting toward the positive direction of the Y-axis). In the same manner, when the driving source part 140a applies an excitation force for expanding the torsion bar 120a along the Y-axis direction, the driving source part 140b also preferably applies an excitation force for expanding the torsion bar 120b along the Y-axis direction. As a result, when the torsion bar 120a is expanded along the Y-axis direction, the torsion bar 120b is also expanded along the Y-axis direction. More specifically, as shown in FIG. 2(b), when the driving source part 140a applies an excitation force for expanding the torsion bar 120a along the Y-axis direction (specifically, for example, a force pulling the torsion bar 120a toward the positive direction of the Y-axis (upward in FIG. 2(a)) and a force acting toward the positive direction of the Y-axis), the driving source part 140b also preferably applies an excitation force for expanding the torsion bar 120b in the Y-axis direction (specifically, for example, a force pulling the torsion bar 120b toward the negative direction (downward in FIG. 2(a)) of the Y-axis and a force acting toward the negative direction of the Y-axis).

Moreover, the absolute value of the amount of expansion and contraction of the torsion bar 120a is preferably the same as the absolute value of the amount of expansion and contraction of the torsion bar 120b.

For example, if an elastic modulus of the torsion bar 120a is equal to an elastic modulus of the torsion bar 120b, the absolute value of the excitation force applied to the torsion bar 120a from the driving source part 140a is preferably the same as the absolute value of the excitation force applied to the torsion bar 120b from the driving source part 140b. Specifically, when the driving source part 140a applies an excitation force for compressing the torsion bar 120a by a predetermined amount along the Y-axis direction, the driving source part 140b also preferably applies an excitation force for compressing the torsion bar 120b by the predetermined amount along the Y-axis direction. More specifically, as shown in FIG. 2(b), when the driving source part 140a applies an excitation force for compressing the torsion bar 120a by a predetermined amount along the Y-axis direction (specifically, an excitation force “−A” along the Y-axis direction) (i.e. at a time point of T2), the driving source part 140b also preferably applies an excitation force for compressing the torsion bar 120b by the predetermined amount along the Y-axis direction (specifically, an excitation force “+A” in the Y-axis). In the same manner, when the driving source part 140a applies an excitation force for expanding the torsion bar 120a by a predetermined amount along the Y-axis direction, the driving source part 140b also preferably applies an excitation force for expanding the torsion bar 120b by the predetermined amount along the Y-axis direction. More specifically, as shown in FIG. 2(b), when the driving source part 140a applies an excitation force for expanding the torsion bar 120a by a predetermined amount along the Y-axis direction (specifically, an excitation force “+A” along the Y-axis direction) (i.e. at a time point of T1), the driving source part 140b also preferably applies an excitation force for contracting the torsion bar 120b by the predetermined amount in the Y-axis direction (specifically, an excitation force “−A” in the Y-axis).

Alternatively, if the elastic modulus of the torsion bar 120a is not equal to the elastic modulus of the torsion bar 120b, it is preferable to adjust the absolute value of the excitation force applied to the torsion bar 120a from the driving source part 140a and the absolute value of the excitation force applied to the torsion bar 120b from the driving source part 140b, as occasion demands, such that the absolute value of the amount of expansion and contraction of the torsion bar 120a is the same as the absolute value of the amount of expansion and contraction of the torsion bar 120b.

In addition, each of a cycle of applying the excitation force to the torsion bar 120a from the driving source part 140a (in other words, a cycle of increasing or reducing the excitation force and a cycle of expanding and contracting the torsion bar 120a) and a cycle of applying the excitation force to the torsion bar 120b from the driving source part 140b (in other words, a cycle of increasing or reducing the excitation force and a cycle of expanding and contracting the torsion bar 120b) is preferably a cycle synchronized with a resonance frequency determined by the mirror 130 and the torsion bars 120a and 120b, or a cycle synchronized with a frequency twice the resonance frequency determined by the mirror 130 and the torsion bars 120a and 120b. For example, if the inertia moment of the mirror 130 is I and a torsion spring constant of the torsion bars 120a and 120b when the torsion bars 120a and 120b are regarded as one spring is k, then, each of the cycle of applying the excitation force to the torsion bar 120a from the driving source part 140a and the cycle of applying the excitation force to the torsion bar 120b from the driving source part 140b is preferably synchronized with a frequency synchronized with a frequency of (1/(2π))×√(k/I) (i.e. a cycle of 2π×√(I/k)) or a frequency twice the frequency of (1/(2π))×√(k/I) (i.e. a cycle of π×√(I/k)). Moreover, as a waveform of a signal applied, an arbitrary waveform is used as occasion demands, such as a sine wave, a halfsine wave, a rectangular or square wave, an impulse wave, a sawtooth wave, and a composite wave thereof.

Due to the application of the excitation force in the cycle as described above, as shown in FIG. 2(a), each of the torsion bars 120a and 120b repeatedly expands and contracts along the Y-axis direction in the cycle synchronized with the resonance frequency, or the cycle synchronized with the frequency twice the resonance frequency. By this, vibration caused by the expansion and contraction of the torsion bars 120a and 120b is transmitted to the mirror 130, resulting in the rotation of the mirror 130. In particular, the mirror 130 rotates so as to repeat the rotation operation at the resonance frequency determined by the mirror 130 and the torsion bars 120a and 120b. In other words, the mirror 130 rotates so as to repeat the rotation operation at the resonance frequency in a predetermined range of angles (in other words, so as to repeat a reciprocating operation of the rotation in a predetermined range of angles), as shown in FIG. 2(a). That is, the mirror 130 self-resonates.

Here, the “resonance” is a phenomenon in which the repetition of an infinitesimal force causes infinite displacement. Thus, even if a small excitation force is applied to each of the torsion bars 120a and 120b in order to rotate the mirror 130, a rotation range of the mirror 130 (in other words, an amplitude along the rotational direction) can be set large. In other words, it is possible to set the excitation force required to rotate the mirror 130 relatively small. It is thus possible to reduce the amount of electric power necessary to apply the excitation force required to rotate the mirror 130. Therefore, it is possible to displace the mirror 130 more efficiently, resulting in lower power consumption of the MEMS scanner 100.

In addition, in the first example, each of the driving source parts 140a and 140b applies, to respective one of the torsion bars 120a and 120b, a force acting along a direction perpendicular to the rotational direction of the mirror 130 (in other words, a direction along the central axis of the rotation of the mirror 130, i.e., the Y-axis in the first example) as the excitation force, thereby rotating the mirror 130. In other words, in the first example, even without directly applying a force directly causing the rotation of the mirror 130 (i.e. a force directly acting along the rotational direction of the mirror 130) or a force directly causing a distortion along a torsional direction (i.e. along the rotational direction of the mirror 130) of each of the torsion bars 120a and 120b (in other words, a force acting along the rotational direction of the mirror 130) as the excitation force, it is possible to rotate the mirror 130 in the same aspect as in a case where the force directly causing the distortion along the torsional direction of each of the torsion bars 120a and 120b is applied as the excitation force.

### (2) Second Example

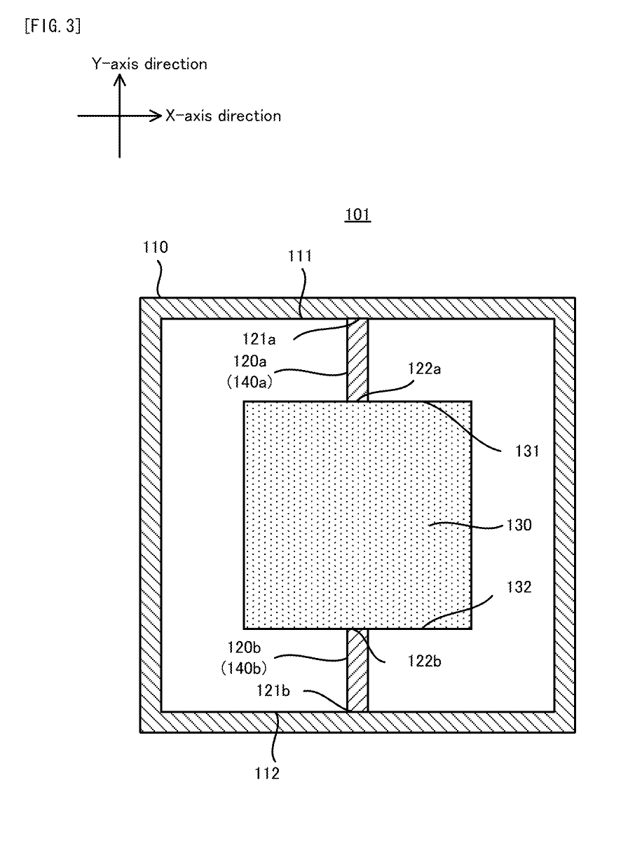

Next, with reference to FIG. 3, a second example of the MEMS scanner will be explained. FIG. 3 is a plan view conceptually showing a configuration of a MEMS scanner 101 in the second example. Incidentally, the same constituents as those of the MEMS scanner 100 in the first example and the MEMS scanner 101 in the second example described above will carry the same reference numerals, and the detailed explanation thereof will be omitted.

As shown in FIG. 3, the MEMS scanner 101 in the second example is provided with: a base 110; a torsion bar 120a; a torsion bar 120b; and a mirror 130, as in the MEMS scanner 100 in the first example.

The MEMS scanner 101 in the second example is different from the MEMS scanner 100 in the first example particularly in that a driving source part 140a is integrated with the torsion bar 120a, that a driving source part 140b is integrated with the torsion bar 120b, and that each of the torsion bars 120a and 120b is provided with a piezoelectric element. Thus, one end 121a of the torsion bar 120a is directly connected to a side 111 on the inner side of the base 110. Moreover, one end 121b of the torsion bar 120b is directly connected to a side 112 on the inner side of the base 110.

Each of the torsion bars 120a and 120b is configured to expand and contract along the Y-axis direction in FIG. 3 by applying a voltage to the piezoelectric element which constitutes the torsion bars 120a and 120b. Thus, the application of the voltage to the torsion bars 120a and 120b allows each of the torsion bars 120a and 120b to expand and contract in the aspects described above. As a result, even without directly applying a force directly causing the rotation of the mirror 130 (i.e. a force directly acting along the rotational direction of the mirror 130) or a force directly causing a distortion along a torsional direction (i.e. along the rotational direction of the mirror 130) of each of the torsion bars 120a and 120b (in other words, a force acting along the rotational direction of the mirror 130) as the excitation force, it is possible to rotate the mirror 130 in the same aspect as in the case where the force directly causing the distortion along the torsional direction of each of the torsion bars 120a and 120b is applied as the excitation force. In other words, it is possible to receive the same effect as that received by the MEMS scanner 100 in the first example.

### (3) Third Example

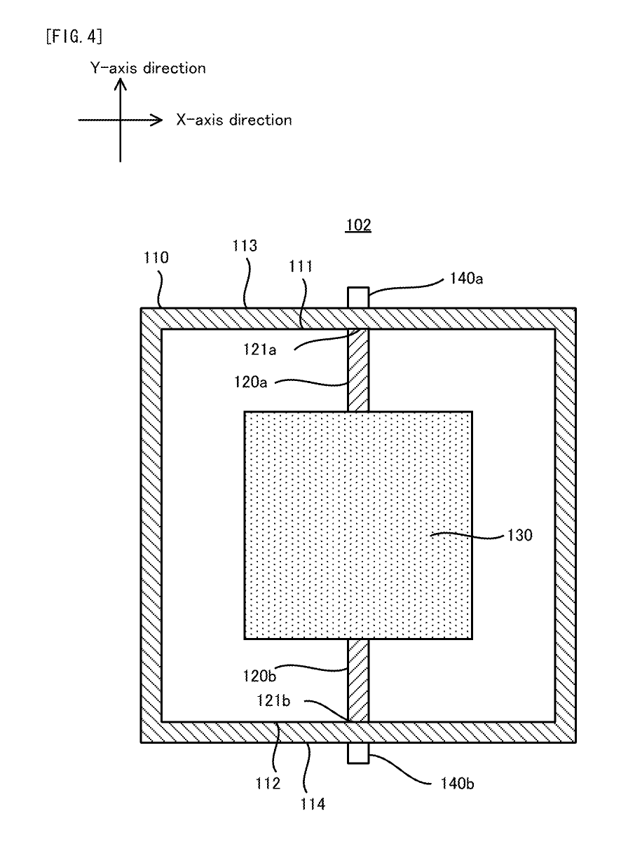

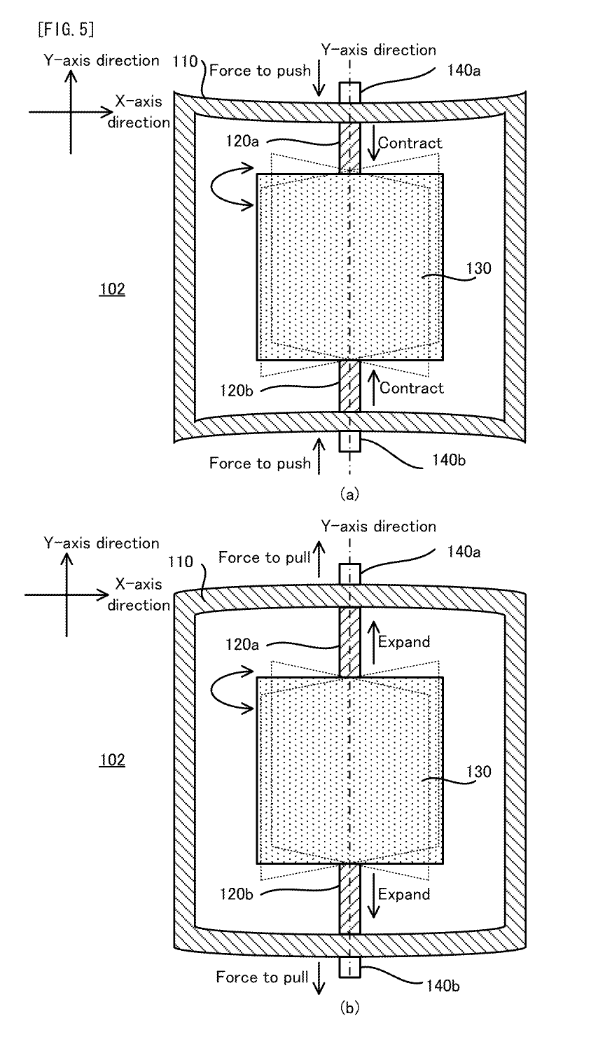

Next, with reference to FIG. 4 and FIG. 5, a third example of the MEMS scanner will be explained.

(3-1) Basic Configuration Firstly, with reference to FIG. 4, a basic configuration of a MEMS scanner 102 in the third example will be explained. FIG. 4 is a plan view conceptually showing the basic configuration of the MEMS scanner 102 in the third example. Incidentally, the same constituents as those of the MEMS scanner 100 in the first example will carry the same reference numerals, and the detailed explanation thereof will be omitted.

As shown in FIG. 4, the MEMS scanner 102 in the third example is provided with: a base 110; a torsion bar 120a; a torsion bar 120b; a mirror 130; a driving source part 140a; and a driving source part 140b, as in the MEMS scanner 100 in the first example.

The MEMS scanner 102 in the third example is different from the MEMS scanner 100 in the first example particularly in the placement position of each of the driving source parts 140a and 140b. More specifically, in the MEMS scanner 102 in the third example, the driving source part 140a is fixed to a side 113 on the outer side of the base 110 (more specifically, a side 113 on the outer side of the base 110 opposed to the aforementioned side 111 on the inner side of the base 110 on the opposite side of the mirror 130). Moreover, one end 121a of the torsion bar 120a is directly fixed to the side 111 on the inner side of the base. In the same manner, the driving source part 140b is fixed to a side 114 on the outer side of the base 110 (more specifically, a side 114 on the outer side opposed to the aforementioned side 112 on the inner side of the base 110 on the opposite side of the mirror 130 and a side 114 opposed to the side 113 on the outer side of the base 110 along the Y-axis direction). Moreover, the other end 121b of the torsion bar 120b is directly fixed to the side 112 on the inner side of the base.

(3-−2) Operation of MEMS Scanner

Next, with reference to FIG. 5, an explanation will be given to an aspect of the operation of the MEMS scanner 102 in the third example (specifically, an aspect of the operation of rotating the mirror 130). FIG. 5 are plan views conceptually showing the aspect of the operation performed by the MEMS scanner 102 in the third example.

As shown in FIG. 5(a) and FIG. 5(b), in the case of rotating the mirror 130, the driving source part 140a applies an excitation force to the base 110 (particular, the side 113 on the outer side of the base 110). In the same manner, the driving source part 140b applies an excitation force to the base 110 (particular, the side 114 on the outer side of the base 110).

Here, if the driving source part 140a applies a force pushing the side 113 on the outer side of the base 110 toward the negative direction of the Y-axis as the excitation force and the driving source part 140b applies a force pushing the side 114 on the outer side of the base 110 toward the positive direction of the Y-axis as the excitation force, each of the side 113 and the side 114 of the base 110 is distorted so as to be pushed toward the space of the base 110, as shown in FIG. 5(a). As a result, each of the torsion bars 120a and 120b is compressed along the Y-axis direction.

In the same manner, if the driving source part 140a applies a force pulling the side 113 on the outer side of the base 110 toward the positive direction of the Y-axis as the excitation force and the driving source part 140b applies a force pulling the side 114 on the outer side of the base 110 toward the negative direction of the Y-axis as the excitation force, each of the side 113 and the side 114 of the base 110 is distorted so as to project from the space of the base 110, as shown in FIG. 5(b). As a result, each of the torsion bars 120a and 120b is expanded along the Y-axis direction.

By repeating the application of the excitation force in a cycle synchronized with a resonance frequency as described above, even in the third example, each of the torsion bars 120a and 120b repeatedly expands and contracts along the Y-axis direction in the cycle synchronized with the resonance frequency. By this, vibration caused by the expansion and contraction of the torsion bars 120a and 120b is transmitted to the mirror 130, resulting in the rotation of the mirror 130. In particular, the mirror 130 rotates so as to repeat the rotation operation at the resonance frequency determined by the mirror 130 and the torsion bars 120a and 120b. In other words, the mirror 130 rotates so as to repeat the rotation operation at the resonance frequency in a predetermined range of angles (in other words, so as to repeat a reciprocating operation of the rotation in a predetermined range of angles), as shown in FIG. 5(a) and FIG. 5(b). That is, the mirror 130 self-resonates. Therefore, even in the MEMS scanner 102 in the third example, as in the MEMS scanner 100 in the first example, even without directly applying a force directly causing the rotation of the mirror 130 (i.e. a force directly acting along the rotational direction of the mirror 130) or a force directly causing a distortion along a torsional direction (i.e. in the rotational direction of the mirror 130) of each of the torsion bars 120a and 120b (in other words, a force acting along the rotational direction of the mirror 130) as the excitation force, it is possible to rotate the mirror 130 in the same aspect as in the case where the force directly causing the distortion along the torsional direction of each of the torsion bars 120a and 120b is applied as the excitation force. In other words, it is possible to receive the same effect as that received by the MEMS scanner 100 in the first example.

In addition, in the third example, the excitation force is applied to the base 110. In other words, each of the driving source parts 140a and 140b for applying the excitation force is fixed to the base 110. Therefore, it is not necessary to fix the driving source parts 140a and 140b to a movable part including the torsion bars 120a and 120b and the mirror 130. This makes it possible to relatively suppress the generation of heat caused by the driving source parts 140a and 140b in the movable part including the torsion bars 120a and 120b and the mirror 130. As a result, it is possible to preferably suppress an adverse influence of the heat on the movable part including the torsion bars 120a and 120b and the mirror 130.

Moreover, since the excitation force is applied to the base 110, it is not necessary to provide the driving source parts 140a and 140b for the movable part including the torsion bars 120a and 120b and the mirror 130. Thus, the excitation force can be applied without increasing the mass of the movable part including the torsion bars 120a and 120b and the mirror 130. Therefore, it is possible to increase sensitivity associated with the displacement of the mirror 130.

Incidentally, in the MEMS scanner 102 in the third example, the extraction and contraction along the Y-axis direction of each of the torsion bars 120a and 120b are realized by using the distortion of the base 110. Thus, in the MEMS scanner 102 in the third example, the base 110 is preferably fixed in a state of substantially allowing the distortion of each of a structure portion including the side 113 and a structural portion including the side 114, instead of being completely fixed.

Moreover, it is obvious that the various configurations explained in the first example and the second example described above may be applied to the MEMS scanner 102 in the third example described above, as occasion demands.

Incidentally, in the first to third examples described above, the MEMS scanners 100 to 102 for rotating the mirror 130 around the Y-axis are explained. In other words, in the first and second examples described above, the MEMS scanner which adopts a uniaxial rotational drive method is explained. However, the aforementioned configuration may be adopted for a MEMS scanner which rotates the mirror 130 around the Y-axis and which rotates the mirror 130 around the X-axis. In this case, the mirror 130 may be rotated around the Y-axis by applying an excitation force for expanding and contracting, along the Y-axis direction, a torsion bar 120 extending along the Y-axis direction, the mirror 130 may be rotated around the X-axis by applying an excitation force for expanding and contracting, along the X-axis direction, the torsion bar 120 extending along the X-axis direction. Alternatively, the mirror 130 may be rotated around the Y-axis by applying an excitation force for expanding and contracting, along the Y-axis direction, the torsion bar 120 extending along the Y-axis direction, the mirror 130 may be rotated around the X-axis by applying an excitation force for twisting, along the torsional direction (i.e. along the rotational direction around the X-axis), the torsion bar 120 extending along the X-axis direction.

### (4) Fourth Example

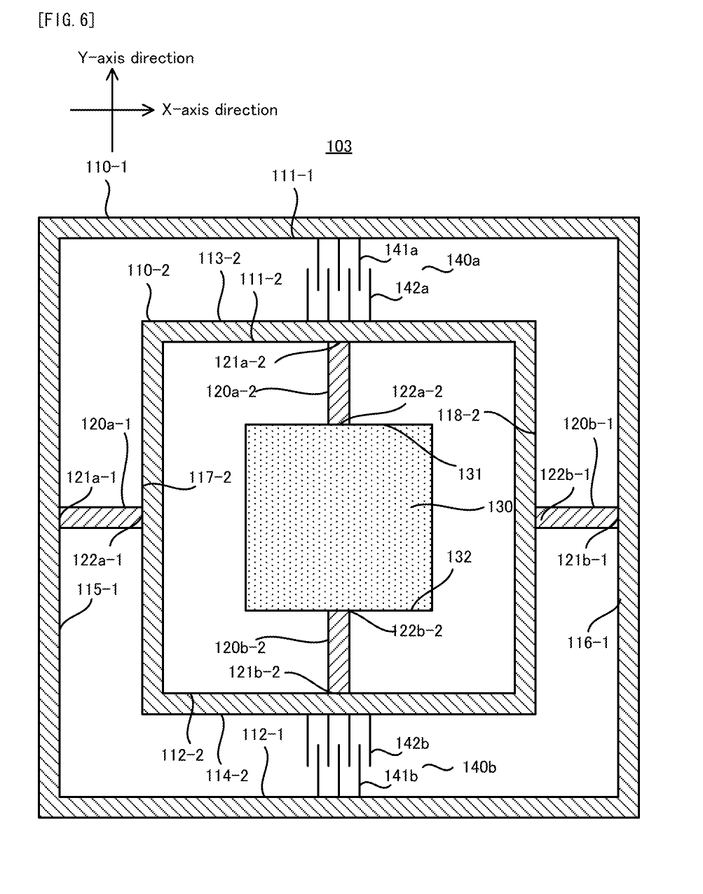

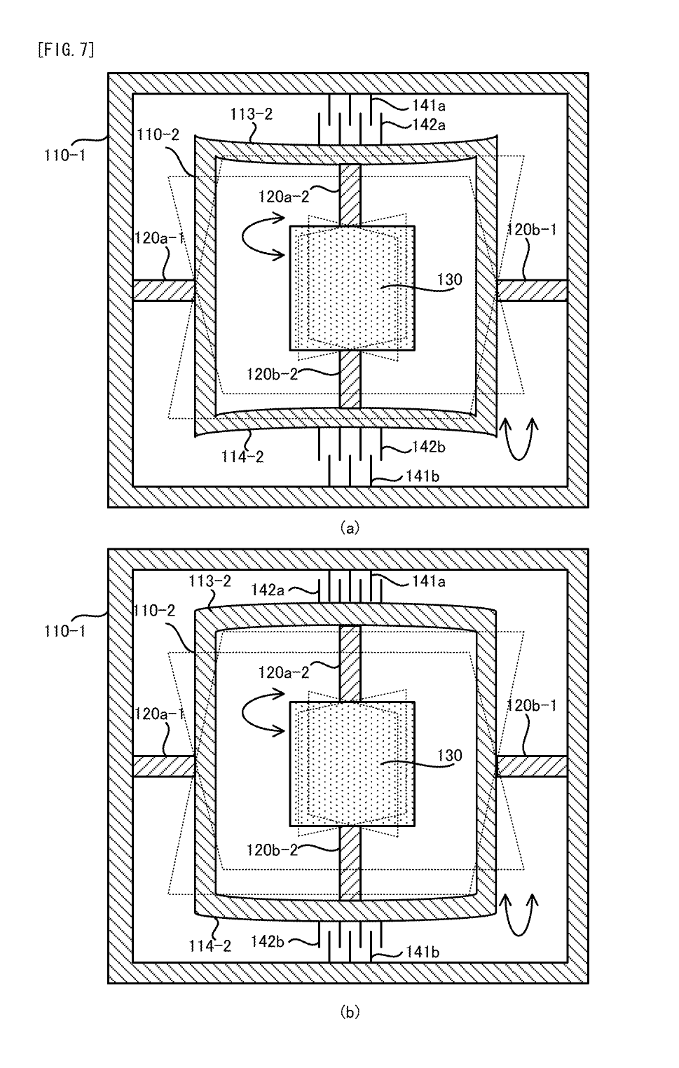

Next, with reference to FIG. 6 and FIG. 7, a fourth example of the MEMS scanner will be explained.

(4-1) Basic Configuration

Firstly, with reference to FIG. 6, a basic configuration of a MEMS scanner 103 in the fourth example will be explained. FIG. 6 is a plan view conceptually showing the basic configuration of the MEMS scanner 103 in the fourth example. Incidentally, the same constituents as those of the MEMS scanner 102 in the third example will carry the same reference numerals, and the detailed explanation thereof will be omitted.

As shown in FIG. 6, the MEMS scanner 103 in the fourth example is provided with: a first base 110-1 which constitutes one specific example of the “first base part” described above; a first torsion bar 120a-1 which constitutes one specific example of the “first elastic part” described above; a first torsion bar 120b-1 which constitutes one specific example of the “first elastic part” described above; a second base 110-2 which constitutes one specific example of the “second base part” described above; a second torsion bar 120a-2 which constitutes one specific example of the “second elastic part” described above; a second torsion bar 120b-2 which constitutes one specific example of the “second elastic part” described above; a mirror 130 which constitutes one specific example of the “driven part” described above; a driving source part 140a which constitutes one specific example of the “applying part” described above; and a driving source part 140b which constitutes one specific example of the “applying part” described above.

The first base 110-1 has a frame shape with a space therein. In other words, the first base 110-1 has a frame shape having two sides extending along the Y-axis direction in FIG. 6 and two sides extending along the X-axis direction (i.e. an axial direction perpendicular to the Y-axis) in FIG. 6 and having a space surrounded by the two sides extending along the Y-axis direction and the two sides extending along the X-axis direction. In an example shown in FIG. 6, the first base 110-1 has, but not limited to, a square shape. For example, the first base 110-1 may have another shape (e.g. rectangular shape such as an oblong, a circular shape, etc.). Moreover, the first base 110-1 is a structure which is the foundation of the MEMS scanner 103 in the fourth example and is preferably fixed to a not-illustrated substrate or support member (in other words, is fixed in the inside of a system which is the MEMS scanner 103).

Incidentally, FIG. 6 shows the example in which the first base 110-1 has the frame shape, but obviously the first base 110-1 may have another shape. For example, the first base 110-1 may have a box shape with a space therein. In other words, the first base 110-1 may have a box shape having two surfaces distributed on a plane defined by the X-axis and the Y-axis, two surfaces distributed on a plane defined by the X-axis and the not-illustrated Z-axis (i.e. the Z axis perpendicular to both the X-axis and the Y-axis), and two surfaces distributed on a plane defined by the Y-axis and the not-illustrated Z-axis, and having a space surrounded by the six surfaces. Alternatively, the shape of the first base 110-1 may be arbitrarily changed depending on an arrangement aspect of the mirror 130.

The first torsion bar 120a-1 is, for example, an elastic member such as a spring made of silicone, copper alloy, iron-based alloy, other metal, resin, or the like. The first torsion bar 120a-1 is disposed to extend along the X-axis direction in FIG. 6. In other words, the first torsion bar 120a-1 has a shape having a long side extending along the X-axis direction and a short side extending along the Y-axis direction. However, in accordance with a setting situation of a resonance frequency described later, the first torsion bar 120a-1 may have a shape having a short side extending along the X-axis direction and a long side extending along the Y-axis direction. One end 121a-1 of the first torsion bar 120a-1 is connected to a side 115-1 on the inner side of the first base 110-1. The other end 122a-1 of the first torsion bar 120a-1 is connected to a side 117-2 on the outer side of the second base 110-2 opposed to the side 115-1 on the inner side of the first base 110-1 along the X-axis direction.

In the same manner, the first torsion bar 120b-1 is, for example, an elastic member such as a spring made of silicone, copper alloy, iron-based alloy, other metal, resin, or the like. The first torsion bar 120b-1 is disposed to extend along the X-axis direction in FIG. 6. In other words, the first torsion bar 120b-1 has a shape having a long side extending along the X-axis direction and a short side extending along the Y-axis direction. However, in accordance with the setting situation of the resonance frequency described later, the first torsion bar 120b-1 may have a shape having a short side extending along the X-axis direction and a long side extending along the Y-axis direction. One end 121b-1 of the first torsion bar 120b-1 is connected to a side 116-1 on the inner side of the first base 110-1 opposed to the side (in other words, area portion) 115-1 on the inner side of the first base 110-1 along the X-axis direction (i.e. the side 115-1 on the inner side of the first base 110-1 to which the one end 121a-1 of the first torsion bar 120a-2 is connected). The other end 122b-1 of the first torsion bar 120b-1 is connected to a side 118-2 on the outer side of the second base 110-2 opposed to the side 116-1 on the inner side of the first base 110-1 along the X-axis direction.

The second base 110-2 has a frame shape with a space therein. In other words, the second base 110-2 has a frame shape having two sides extending along the Y-axis direction in FIG. 6 and two sides extending along the X-axis direction (i.e. the axial direction perpendicular to the Y-axis) in FIG. 6 and having a space surrounded by the two sides extending along the Y-axis direction and the two sides extending along the X-axis direction. In the example shown in FIG. 6, the second base 110-2 has, but not limited to, a square shape. For example, the second base 110-2 may have another shape (e.g. rectangular shape such as an oblong, a circular shape, etc.).

Moreover, the second base 110-2 is disposed in the space in the inside of the first base 110-1 so as to be hung or supported by the first torsion bars 120a-1 and 120b-1. The second base 110-2 is configured to rotate around the X-axis direction, by the elasticity of the first torsion bars 120a-1 and 120b-1.

Incidentally, FIG. 6 shows the example in which the second base 110-2 has the frame shape, but obviously the second base 110-2 may have another shape. For example, the second base 110-2 may have a box shape with a space therein. In other words, the second base 110-2 may have a box shape having two surfaces distributed on a plane defined by the X-axis and the Y-axis, two surfaces distributed on a plane defined by the X-axis and the not-illustrated Z-axis (i.e. the Z axis perpendicular to both the X-axis and the Y-axis), and two surfaces distributed on a plane defined by the Y-axis and the not-illustrated Z-axis, and having a space surrounded by the six surfaces. Alternatively, the shape of the second base 110-2 may be arbitrarily changed depending on the arrangement aspect of the mirror 130.

The second torsion bar 120a-2 is, for example, an elastic member such as a spring made of silicone, copper alloy, iron-based alloy, other metal, resin, or the like. The second torsion bar 120a-2 is disposed to extend along the Y-axis direction in FIG. 6. In other words, the second torsion bar 120a-2 has a shape having a long side extending along the Y-axis direction and a short side extending along the X-axis direction. However, in accordance with the setting situation of the resonance frequency described later, the second torsion bar 120a-2 may have a shape having a short side extending along the Y-axis direction and a long side extending along the X-axis direction. One end 121a-2 of the second torsion bar 120a-2 is connected to a side 111-2 on the inner side of the second base 110-2. The other end 122a-2 of the second torsion bar 120a-2 is connected to one side 131 of the mirror 130 opposed to the side 111-2 on the inner side of the second base 110-2 along the Y-axis direction.

In the same manner, the second torsion bar 120b-2 is, for example, an elastic member such as a spring made of silicone, copper alloy, iron-based alloy, other metal, resin, or the like. The second torsion bar 120b-2 is disposed to extend along the Y-axis direction in FIG. 6. In other words, the second torsion bar 120b-2 has a shape having a long side extending along the Y-axis direction and a short side extending along the X-axis direction. However, in accordance with the setting situation of the resonance frequency described later, the second torsion bar 120b-2 may have a shape having a short side extending along the Y-axis direction and a long side extending along the X-axis direction. One end 121b-2 of the second torsion bar 120b-2 is connected to a side 112-2 on the inner side of the second base 110-2 opposed to the side (in other words, area portion) 111-2 on the inner side of the second base 110-2 along the Y-axis direction (i.e. the side 111-2 on the inner side of the second base 110-2 to which the one end 121a-2 of the second torsion bar 120b-2 is connected). The other end 122b-2 of the second torsion bar 120b-2 is connected to other side 132 of the mirror 130 opposed to the side 112-2 on the inner side of the second base 110-2 along the Y-axis direction.

The mirror 130 is disposed in the space in the inside of the second base 110-2 so as to be hung or supported by the second torsion bars 120a-2 and 120b-2. The mirror 130 is configured to rotate around the Y-axis direction, by the elasticity of the second torsion bars 120a-2 and 120b-2.

The driving source part 140a is fixed to each of a side 111-1 on the inner side of the first base 110-1 and a side 113-2 on the outer side of the second base 110-2 so as to be sandwiched between the side 111-1 on the inner side of the first base 110-1 and the side 113-2 on the outer side of the second base 110-2. More specifically, the MEMS scanner 103 in the fourth example adopts a driving source part for applying a force caused by an electrostatic force, as the driving source part 140a. Thus, the driving source part 140a is provided with: a first comb-like (or interdigitated) electrode 141a fixed to the side 111-1 on the inner side of the first base 110-1; and a second comb-like (or interdigitated) electrode 142a fixed to the side 113-2 on the outer side of the second base 110-2 and distributed in such a manner that the first electrode and the second electrode interdigitate each other. In this case, a desired voltage is applied to the first electrode 141a in desired timing from a not-illustrated driving source part control circuit. Here, due to a potential difference between the first electrode 141a and the second electrode 142a, an electrostatic force (in other words, Coulomb force) is generated between the first electrode 141a and the second electrode 142a. Here, since the first electrode 141a is fixed to the first base 110-1 which is the foundation and the second electrode 142a is fixed to the second base 110-2, a force caused by the electrostatic force is applied to the second base 110-2. As a result, the force caused by the electromagnetic force is applied to the second base 110-2.

The driving source part 140b is fixed to each of a side 112-1 on the inner side of the first base 110-1 and a side 114-2 on the outer side of the second base 110-2 so as to be sandwiched between the side 112-1 on the inner side of the first base 110-1 and the side 114-2 on the outer side of the second base 110-2. More specifically, the MEMS scanner 103 in the fourth example adopts a driving source part for applying a force caused by an electrostatic force, as the driving source part 140b. Thus, the driving source part 140b is provided with: a first comb-like (or interdigitated) electrode 141b fixed to the side 112-1 on the inner side of the first base 110-1; and a second comb-like (or interdigitated) electrode 142b fixed to the side 114-2 on the outer side of the second base 110-2 and distributed in such a manner that the first electrode and the second electrode interdigitate each other. In this case, a desired voltage is applied to the first electrode 141b in desired timing from a not-illustrated driving source part control circuit. Here, due to a potential difference between the first electrode 141b and the second electrode 142b, an electrostatic force (in other words, Coulomb force) is generated between the first electrode 141b and the second electrode 142b. Here, since the first electrode 141b is fixed to the first base 110-1 which is the foundation and the second electrode 142b is fixed to the second base 110-2, a force caused by the electrostatic force is applied to the second base 110-2. As a result, the force caused by the electromagnetic force is applied to the second base 110-2.

Incidentally, in the fourth example, the driving source parts 140a and 140b for applying the force caused by the electrostatic force are used for the explanation; however, as described above, it is obvious that a driving source part for applying a force caused by a piezoelectric effect and a driving source part for applying a force caused by an electromagnetic force may be adopted.

(4-2) Operation of MEMS Scanner

Next, with reference to FIG. 7, an explanation will be given to an aspect of the operation of the MEMS scanner 103 in the fourth example (specifically, an aspect of the operation of rotating the mirror 130). FIG. 7 are plan views conceptually showing the aspect of the operation performed by the MEMS scanner 103 in the fourth example.

As shown in FIG. 7(a) and FIG. 7(b), when the mirror 130 rotates, the driving source part 140a applies the force caused by the electrostatic force to the second base 110-2 (particular, the side 113-2 on the outer side of the second base 110-2). In the same manner, the driving source part 140b applies the force caused by the electrostatic force to the second base 110-2 (particularly, the side 114-2 on the outer side of the second base 110-2).

At this time, the second base 110-2 to which the force caused by the electrostatic force is applied from each of the driving source parts 140a and 140b rotates around the X-axis direction, using the elasticity of the first torsion bars 120a-1 and 120b-1, as shown in FIG. 7(a) and FIG. 7(b).

At the same time, in the second base 110-2, in accordance with the force caused by the elastic force applied from each of the driving source parts 140a and 140b, the side 113-2 on the outer side is pushed toward the negative direction of the Y-axis, and the side 114-2 on the outer side is pushed toward the positive direction of the Y-axis. As a result, as shown in FIG. 7(a), each of the side 113-2 and the side 114-2 of the second base 110-2 is distorted so as to be pushed toward the space of the second base 110-2. As a result, each of the second torsion bars 120a-2 and 120b-2 is compressed along the Y-axis direction.

In the same manner, in the second base 110-2, in accordance with the force caused by the elastic force applied from each of the driving source parts 140a and 140b, the side 113-2 on the outer side is pulled toward the positive direction of the Y-axis, and the side 114-2 on the outer side is pulled toward the negative direction of the Y-axis. As a result, as shown in FIG. 7(b), each of the side 113-2 and the side 114-2 of the second base 110-2 is distorted so as to project from the space of the second base 110-2. As a result, each of the second torsion bars 120a-2 and 120b-2 is expanded along the Y-axis direction.

In other words, in the third example, in the inside of a system which includes the second base 110-2, the second torsion bars 120a-2 and 120b-2, and the mirror 130, the mirror 130 rotates around the axis along the Y-axis, in the same aspect as that of the MEMS scanner 102 in the third example. At this time, since the second base 110-2 for supporting the mirror 130 rotates around the axis along the X-axis, the mirror 130 rotates around the axis along the Y-axis and around the axis along the X-axis. Therefore, it is possible to realize biaxial rotational drive of the mirror 130.

In particular, in the fourth example, a force for rotating the second base 110-2 around the axis along the X-axis can be used as a force for rotating the mirror 130 around the axis along the Y-axis (i.e. as an excitation force and a force for expanding and contracting the second torsion bars 120a-2 and 120b-2). Thus, there is such an extremely useful effect in practice that it is not necessary to separately and independently provide an applying part for applying the force for rotating the second base 110-2 around the axis along the X-axis and an applying part for applying the force for rotating the mirror 130 around the axis along the Y-axis.

Incidentally, in the explanation described above, for simplification or clarification of the explanation, an example in which the torsion bars 120a and 120b have long sides along a direction of the rotation axis of the mirror 130 is explained. However, the torsion bars 120a and 120b may have short sides along the direction of the rotation axis of the mirror 130 (i.e. the torsion bars 120a and 120b may have long sides along a direction perpendicular to the direction of the rotation axis of the mirror 130). In this case, the torsion bars 120a and 120b have higher resonance frequencies in comparison with the case where the torsion bars 120a and 120b have long sides along the direction of the rotation axis of the mirror 130.

In the present invention, various changes may be made, if desired, without departing from the essence or spirit of the invention which can be read from the claims and the entire specification. A driving apparatus, which involves such changes, is also intended to be within the technical scope of the present invention.

### DESCRIPTION OF REFERENCE CODES

100 MEMS scanner
110 base
120 torsion bar
130 mirror
140 driving source part

1. A driving apparatus comprising:
a base part;
a driven part capable of rotating around an axis along one direction;
an elastic part which connects the base part and the driven part and which extends along the one direction; and
an applying part for applying a force for expanding and contracting the elastic part along the one direction as an excitation force for rotating the driven part such that the driven part resonates at a resonance frequency determined by the elastic part and the driven part.

2. The driving apparatus according to claim 1, wherein the elastic part is integrated with the applying part and includes a piezoelectric element.

3. The driving apparatus according to claim 1, wherein
the applying part directly applies, to the elastic part, the force for expanding and contracting the elastic part along the one direction as the excitation force, and
the elastic part is expanded and contracted along the one direction due to the excitation force.

4. The driving apparatus according to claim 1, wherein
the base part has a frame shape with a space therein,
the driven part is disposed in the space of the base part so as to be surrounded by the base part,
one end of the elastic part along the one direction is connected to the base part, and the other end of the elastic part along the one direction is connected to the driven part,
the applying part applies, to the base part, the force for expanding and contracting the elastic part along the one direction as the excitation force, and
the base part is distorted due to the excitation force, and the elastic part is expanded and contracted along the one direction in accordance with the distortion of the base part.

5. The driving apparatus according to claim 1, wherein
the base part has a frame shape with a space therein,
the driven part is disposed in the space of the base part so as to be surrounded by the base part,
the elastic part comprises: (i) a one-side elastic part for connecting one area portion out of two area portions of the base part which face to each other along the one direction and an area portion of the driven part facing to the one area portion; and (ii) an other-side elastic part for connecting the other area portion out of the two area portions of the base part which face to each other along the one direction and an area portion of the driven part facing to the other area portion, and
the applying part applies the excitation force such that an aspect of expanding and contracting the one-side elastic part is synchronized with an aspect of expanding and contracting the other-side elastic part are synchronized with each other.

6. The driving apparatus according to claim 5, wherein the applying part applies the excitation force such that an absolute value of an amount of expansion and contraction of the one-side elastic part is same as an absolute value of an amount of expansion and contraction of the other-side elastic part.

7. The driving apparatus according to claim 1, wherein
the base part comprises: a first base part; and a second base part surrounded by the first base part,
the elastic part comprises: a first elastic part which connects the first base part and the second base part and which extends along another direction which is different from the one direction; and a second elastic part which connects the second base part and the driven part and which extends along the one direction, and
the applying part (i) applies a driving force for rotating the second base part around an axis along the another direction and (ii) uses the driving force as the excitation force which becomes a force for expanding and contracting the second elastic part along the one direction.
